(19) United States
(12) Patent Application Publication
(10) Pub. No.: US 2007/0053512 A1
(43) Pub. Date: Mar. 8, 2007

(54) Method and apparatus for improving security in a voice over internet protocol session

(75) Inventor: Edward Walter, Boerne, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/218,675

(22) Filed: Sep. 2, 2005

(51) Int. Cl. H04L 9/00

(52) U.S. Cl. 380/42

(57) ABSTRACT

A method and apparatus are disclosed for security in a VoIP (Voice over Internet Protocol) message. A system that incorporates teachings of the present disclosure may include, for example, an access point (104) has a transceiver (302) for coupling a VoIP terminal (102) with a communications network (110), and a processor (304). The processor is programmed to intercept (302) a VoIP (Voice over Internet Protocol) message from the VoIP terminal, interleave (306) portions of the VoIP message into two or more packet streams, encrypt (310) each packet stream, and transmit (316) each encrypted packet stream in distinct communication channels of the communication network.

### RELATED APPLICATION

U.S. patent application Ser. No. 11/196,615, filed Aug. 3, 2005, by Marathe et al., entitled “Method and Apparatus for Improving Communication Security.”

### FIELD OF THE DISCLOSURE

The present disclosure relates generally to VoIP (Voice over Internet Protocol) services, and more specifically to a method and apparatus for security in a VoIP message.

### BACKGROUND

The ubiquity of communication systems has made it very simple for consumers to stay in touch nearly anywhere at anytime. With this expansive growth, however, the security of such communications has become a rising concern. To protect communications (on wired or wireless means), encryption methods have been deployed widely.

Although this has substantially improved security, encryption methods have been known to be successfully deciphered by intruders for the purpose of stealing proprietary information such as credit card information, or by hackers for the purposes of changing or destroying information as a form of cyber-terrorism. These issues are also pertinent to sensitive voice communications taking place in a VoIP environment.

A need therefore arises for a method and apparatus for secure communications with VoIP messages.

### BRIEF DESCRIPTION OF THE DRAWINGS

FIGS. 1-2 are block diagrams of end-to-end communications between VoIP terminals 102 coupled to corresponding access points 104 incorporating teachings of the present disclosure;

FIG. 3 is block diagram of the components of the VoIP terminal and the access point, respectively, according to teachings of the present disclosure;

FIG. 4 depicts a flowchart of a method operating in the VoIP terminal, or alternatively, in the access point according to teachings of the present disclosure; and

FIG. 5 is a diagrammatic representation of a machine in the form of a computer system within which a set of instructions, when executed, may cause the machine to perform any one or more of the methodologies discussed herein.

### DETAILED DESCRIPTION OF THE DRAWINGS

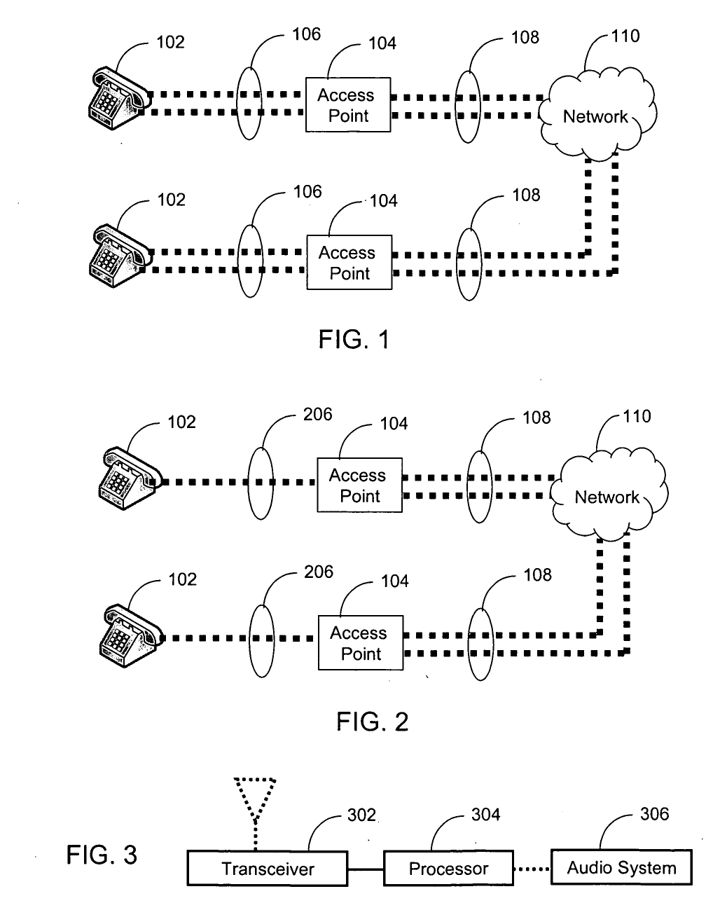

FIGS. 1-2 are block diagrams of end-to-end communications between VoIP terminals 102 coupled to corresponding access points 104 incorporating teachings of the present disclosure. The communication network 110 shown in FIGS. 1 and 2 include a number of conventional network elements (not shown) for providing communication services to customers of the service provider of said network. The communication network 110 can support Internet services utilizing technologies such as IP (Internet Protocol), MPLS (multi-protocol label switching), and FR/ATM (Frame Relay/Asynchronous Transfer Mode), just to mention a few.

The VoIP terminal 102 utilizes conventional processing technology for providing users voice, data, video conferencing and other common features available to VoIP terminals. The VoIP terminal 102 comprises conventional technology 300 shown in FIG. 3, which includes a transceiver 302, an audio system 304, and a processor 304. The transceiver 302 can utilize a wired or wireless interface 106 (or 206) for exchanging VoIP messages with the access point 104. In the case of wired communications, the transceiver 302 can utilize any conventional communications protocol such as, for example, Ethernet. For wireless communications, the transceiver 302 can utilize any conventional wireless communications protocol such as, for example, IEEE 802.11 a/b/g, Bluetooth™, cellular protocols such as CDMA 1×, EV/DO, GSM, GPRS, TDMA, Edge, and so on.

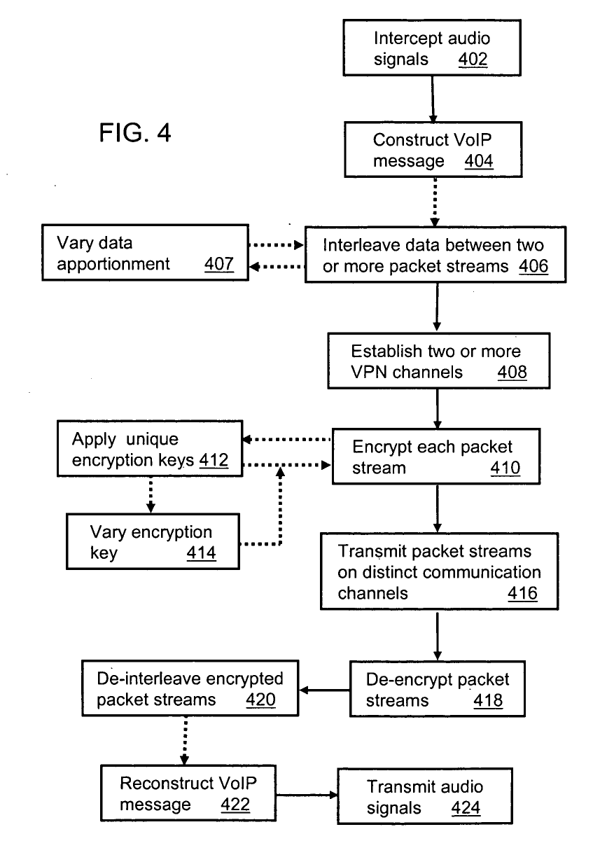

The audio system 306 can utilize conventional sampling and processing technology for conveying and intercepting audio signals with a user of the VoIP terminal 102. The processor 304 utilizes conventional computing technology such as a microprocessor and/or DSP (Digital Signal Processor) with associated storage such as a mass storage media disk drive, ROM, RAM, DRAM, SRAM, Flash and/or other like devices. The processor 304 controls general operations of the VoIP terminal 102, and particularly performs signal processing on secure messages exchanged with the access point 104 in accordance with an embodiment of the present disclosure depicted in the flowchart of FIG. 4.

The access point 104 can represent any conventional point of entry into a communication system (e.g., DSL—Digital Subscriber Line, Cable, ISDN—Integrated Services Digital Network, Ethernet, or cellular networks, just to mention a few). Like the VoIP terminal 102, the access point 104 incorporates similar components to those shown in FIG. 3 with the exception of the audio system 306, and can be used for the purpose of exchanging secure end-to-end messages between access points 104 and/or VoIP terminals 102. The transceiver 302 of the access point 104, however, serves a dual purpose. That is, it is utilized for exchanging messages with the VoIP terminal 102 and the communication network 110, respectively. Interfaces 106, 206 which couple the VoIP terminal 102 and the access point 104 can be a wired or wireless interface utilizing technologies similar to those described above for the transceiver of the VoIP terminal 102. Interface 108, which couples the access point 104 to the communication network 110, can utilize conventional technology that complies with any of the communication protocols described earlier for the communication network 110.

FIG. 1 depicts a first embodiment 100 in which a VoIP terminal 102 establishes end-to-end security with a corresponding VoIP terminal 102. FIG. 2, on the other hand, represents a second embodiment 200 where an access point 104 establishing end-to-end security with another access point 104 with minimal or no security at interface 206. Each of these embodiments is further explained in the flowchart of FIG. 4.

FIG. 4 depicts a flowchart of a method 400 operating in the communication system of the VoIP terminal 102, or alternatively, the access point 104 according to teachings of the present disclosure. Steps 402 through 424 of FIG. 4 depict the operation of a VoIP terminal 102 in accordance with an embodiment of the present disclosure. Steps 406 through 420 depict the operation of an access point 104 as an alternative embodiment of the present disclosure. Beginning with the embodiment of operation for the VoIP terminal 102, it should be noted that steps 402 through 416 represent outbound traffic while steps 418 through 424 represent inbound traffic.

With this in mind, method 400 begins with step 402 where the processor 304 causes the audio system 306 to intercept audio signals from the user of the VoIP terminal 102. The processor 304 in step 404 then processes the audio signals and constructs a VoIP message according to conventional VoIP protocols. In step 406, the processor 304 is programmed to interleave portions of the VoIP message into two or more packet streams. In the present context, interleaving means a random or pseudo-random division of contiguous data between packet streams destined to be carried by distinct communication channels. Referring back to FIG. 1, interface 106 shows two lines in order to represent logical or physical connections for transmitting packet streams in two channels. In prior art systems, a secure channel such as a virtual private network (VPN) transforms contiguous data into a secured packet stream on a single channel. In the present disclosure, packet streams are interleaved in separate logical or physical channels to prevent tampering or monitoring of secure messages.

In step 408 two or more VPN channels can be established to carry the interleaved packet streams created in step 406. Each packet stream is encrypted according to conventional techniques in step 410, and transmitted in step 416 on distinct VPN channels through the communication network 110 destined for the receiving VoIP terminal 102. This completes the outbound traffic. Referring now to the inbound traffic, in step 412 the encrypted packet streams are decrypted in step 418, and deinterleaved in step 420. The VoIP message is reconstructed in step 422 from the deinterleaved data with the result transmitted to the audio system 306 for conveying audio signals to the user of the VoIP terminal 102.

By interleaving data between VPN channels, it becomes exceedingly difficult for an intruder to monitor information transmitted between the VoIP terminals 102. This is because it will be very difficult for the intruder to decipher which interleaving algorithm is in use. The VoIP terminals 102 can have synchronized clocks, which allow them to interleave data between VPN channels in a pseudo-random manner. Additionally, any number of VPN channels can be created to augment the interleaving process and security.

The foregoing method can be applied to the access points 104 with the exception of steps 402-404 and 422-424. In this embodiment, the VoIP terminals 102 can employ unsecured interfaces 206 with a corresponding access point 104. This embodiment can be useful when, for example, interface 206 is a short wireline in a secure building or dwelling where security is not a concern. This embodiment also removes the expense and complexity of adding encryption techniques to the VoIP terminal 102.

Supplemental embodiments can also be applied to further increase the difficulty of monitoring or penetrating a secure communication. For example, in step 407 the apportionment of data between packet streams can be varied. This variance can be periodic or pseudo-random. As such, an intruder would further have a difficult time deciphering information captured on one VPN channel, not to mention the others. Moreover, in step 412 unique and distinct encryption keys can be applied to each packet stream, and over the course of time said keys can be varied in step 414 so as randomize encryption on the VPN channels.

Thus, as these aforementioned embodiments are applied, it becomes very challenging for intruders (“hackers”) to break through a secure VoIP communication link operating according to the present disclosure.

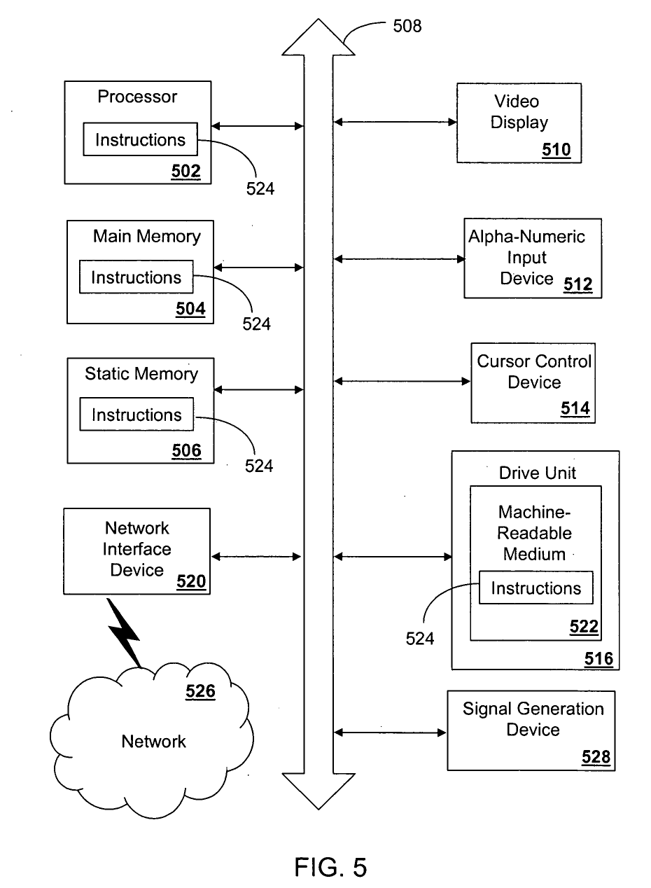

FIG. 5 is a diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated in herein above. The instructions 524 may also reside, completely or at least partially, within the main memory 504, the static memory 506, and/or within the processor 502 during execution thereof by the computer system 500. The main memory 504 and the processor 502 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. For example, method 400 can be reduced to steps 402, 404, 406 and 412 without departing from the scope of the claims described below. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An access point, comprising:
a transceiver for coupling a VoIP terminal with a communications network; and
a processor programmed to:
intercept a VoIP (Voice over Internet Protocol) message from the VoIP terminal;
interleave portions of the VoIP message into two or more packet streams;
encrypt each packet stream; and
transmit each encrypted packet stream in distinct communication channels of the communication network.

2. The access point of claim 1, wherein the processor is programmed to establish a virtual private network (VPN) at each communication channel.

3. The access point of claim 1, wherein the processor is programmed to apply a unique encryption key to each packet stream.

4. The access point of claim 3, wherein the processor is programmed to vary the unique encryption key.

5. The access point of claim 1, wherein the processor is programmed to vary the apportionment of data between the two or more packet streams.

6. The access point of claim 1, wherein the processor is programmed to:
decrypt each packet stream; and
deinterleave the decrypted packet streams.

7. A VoIP terminal, comprising:
a transceiver for coupling to an access point;
an audio system; and
a processor programmed to:
intercept audio signals of a user of the VoIP terminal;
construct a VoIP message from the intercepted audio signals;
interleave portions of the VoIP message into two or more packet streams;
encrypt each packet stream; and
transmit each encrypted packet stream in distinct communication channels.

8. The VoIP of claim 7, wherein the processor is programmed to establish a virtual private network (VPN) at each communication channel.

9. The VoIP of claim 7, wherein the processor is programmed to apply a unique encryption key to each packet stream.

10. The VoIP of claim 9, wherein the processor is programmed to vary the unique encryption key.

11. The VoIP of claim 7, wherein the processor is programmed to vary the apportionment of data between the two or more packet streams.

12. The VoIP of claim 7, wherein the processor is programmed to:
decrypt each packet stream; and
deinterleave the decrypted packet streams.

13. The VoIP of claim 12, wherein the processor is programmed to:
reconstruct the VoIP message from the deinterleaved packet streams; and
transmit audio signals to the user corresponding to the VoIP message.

14. A computer-readable storage medium, comprising computer instructions for:
interleaving portions of a VoIP (Voice over Internet Protocol) message into two or more packet streams;
encrypting each packet stream; and
transmitting in a communication network each encrypted packet stream in distinct communication channels.

15. The storage medium of claim 14, comprising computer instructions for establishing a virtual private network (VPN) at each communication channel.

16. The storage medium of claim 14, comprising computer instructions for applying a unique encryption key to each packet stream.

17. The storage medium of claim 16, comprising computer instructions for varying the unique encryption key.

18. The storage medium of claim 14, comprising computer instructions for varying the apportionment of data between the two or more packet streams.

19. The storage medium of claim 14, comprising computer instructions for:
decrypting each packet stream; and
deinterleaving the decrypted packet streams.

20. The storage medium of claim 14, wherein the computer-readable storage medium operates in at least one among a VoIP terminal, and an access point.
